(19) United States
(12) Patent Application Publication
(10) Pub. No.: US 2019/0286671 A1
(43) Pub. Date: Sep. 19, 2019

(54) ALGORITHMIC COMPUTATION OF ENTITY INFORMATION FROM IP ADDRESS

(71) Applicant: Alert-On, LLC, Germantown, MD (US)

(72) Inventors: Vinh Vo, Germantown, MD (US); Victorvan Rojas, Germantown, MD (US)

(21) Appl. No.: 16/356,999

(22) Filed: Mar. 18, 2019

Related U.S. Application Data
(60) Provisional application No. 62/644,438, filed on Mar. 17, 2018.

(51) Int. Cl. G06F 16/955; G06F 16/21; G06F 16/958; G06F 9/54; G06F 16/951; G06F 16/9535; G06F 16/9538; G06F 17/27

(52) U.S. Cl. CPC G06F 16/955; G06F 16/219; G06F 16/958; G06F 17/278; G06F 16/951; G06F 16/9535; G06F 16/9538; G06F 9/547

(57) ABSTRACT

A method and system are provided for associating an entity to an IP address of a non-logged-in user. Determination of the entity may be based on multiple sets of information that may be queried based on the IP address. Some of the information may be collected from prior web form entries. In some embodiments, web form entries are associated with a hash.

### CROSS-REFERENCE TO RELATED APPLICATION

This application claims the benefit of U.S. Provisional Patent Application No. 62/644,438, filed Mar. 17, 2018, which is hereby incorporated by reference in its entirety.

### FIELD OF THE INVENTION

The present invention relates to determining entity information from an IP address.

### BACKGROUND

Currently, website owners do not receive enough information about anonymous users who visit their websites. Anonymous users are non-logged-in users, who traditionally, have little information associated with them from the website owner's point of view. The website owner may know only the Internet Protocol (IP) address of the user. This is less than optimal because the website owner is not able to determine information about the user, such as the business entity that the user works for.

Existing methodologies for matching an IP address to entity information include checking registries such the American Registry for Internet Numbers (ARIN) and Réseaux IP Européens (RIPE), which track IP address related information, such as an organization owning a given block of IP addresses. However, these registries often lack accurate information about the true identity of an organization using a given IP address.

For example, the registries list the names of Internet service providers (ISP) owning large blocks of addresses, but do not identify small businesses to which the ISP has sub-leased a small block of fixed IP addresses within the ISP's larger block except in limited circumstances. Additionally, changes in organizational identity or structure, such as those triggered by business mergers and acquisitions, are often not reflected in the registry, leading to misleading results when performing registry lookups.

It would be desirable to develop a more consistent and sophisticated algorithmic approach to determining the information of users and entities from an IP address or other limited information.

### SUMMARY OF THE INVENTION

One embodiment relates to associating an entity to an IP address of a non-logged-in user. Determination of the entity may be based on multiple sets of information that are queried based on the IP address. The set of candidate entities may be narrowed based on the geolocated location of the IP address. Moreover, the most likely entity may be determined by examining web form information submitted from the IP address to determine entity identity from company name fields or email address fields.

One embodiment relates to retrieving user information from a different location. A user may have a session token tracking their online activity. The session token may be stored along with a hash of user information. When a user visits a website, the session token may be used to retrieve the hash of user information. The hash of user information may then be used to look up information in a database.

One embodiment relates to a smart web form that may validate or autofill fields based on information retrieved based on IP address, company name, or email address.

One embodiment relates to tracking user information across webpages to infer user interest.

One embodiment relates to implementation of methods herein using Javascript and autoconfiguration from a user interface.

### BRIEF DESCRIPTION OF THE DRAWINGS

FIG. 1 illustrates an exemplary system architecture that may be used in some embodiments.

FIG. 2 illustrates an exemplary method for storing information submitted in a web form associated with an IP address.

FIG. 3 illustrates an exemplary method for associating an entity identity to an IP address.

FIG. 4 illustrates an exemplary method for retrieving user information from a different location.

FIG. 5 illustrates an exemplary method for validating or inserting information into a web form.

FIG. 6 illustrates an exemplary method for validating or inserting information into a web form.

FIG. 7 illustrates an exemplary method for tracking a user journey and inferring user interest.

FIG. 8 illustrates an exemplary method for implementing methods herein with a single Javascript source script.

FIG. 9 illustrates an exemplary user interface for configuring a web form.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Embodiments of the invention may comprise one or more computers. Embodiments of the invention may comprise software and/or hardware. Some embodiments of the invention may be software only and may reside on hardware. A computer may be special-purpose or general purpose. A computer or computer system includes without limitation electronic devices performing computations on a processor or CPU, personal computers, desktop computers, laptop computers, mobile devices, cellular phones, smart phones, PDAs, pagers, multi-processor-based devices, microprocessor-based devices, programmable consumer electronics, cloud computers, tablets, minicomputers, mainframe computers, server computers, microcontroller-based devices, DSP-based devices, embedded computers, wearable computers, electronic glasses, computerized watches, and the like. A computer or computer system further includes distributed systems, which are systems of multiple computers (of any of the aforementioned kinds) that interact with each other, possibly over a network. Distributed systems may include clusters, grids, shared memory systems, message passing systems, and so forth. Thus, embodiments of the invention may be practiced in distributed environments involving local and remote computer systems. In a distributed system, aspects of the invention may reside on multiple computer systems.

Embodiments of the invention may comprise computer-readable media having computer-executable instructions or data stored thereon. A computer-readable media is physical media that can be accessed by a computer. It may be non-transitory. Examples of computer-readable media include, but are not limited to, RAM, ROM, hard disks, flash memory, DVDs, CDs, magnetic tape, and floppy disks.

Computer-executable instructions comprise, for example, instructions which cause a computer to perform a function or group of functions. Some instructions may include data. Computer executable instructions may be binaries, object code, intermediate format instructions such as assembly language, source code, byte code, scripts, and the like. Instructions may be stored in memory, where they may be accessed by a processor. A computer program is software that comprises multiple computer executable instructions.

A database is a collection of data and/or computer hardware used to store a collection of data. It includes databases, networks of databases, and other kinds of file storage, such as file systems. No particular kind of database must be used. The term database encompasses many kinds of databases such as hierarchical databases, relational databases, post-relational databases, object databases, graph databases, flat files, spreadsheets, tables, trees, and any other kind of database, collection of data, or storage for a collection of data.

A network comprises one or more data links that enable the transport of electronic data. Networks can connect computer systems. The term network includes local area network (LAN), wide area network (WAN), telephone networks, wireless networks, intranets, the Internet, and combinations of networks.

In this patent, the term “transmit” includes indirect as well as direct transmission. A computer X may transmit a message to computer Y through a network pathway including computer Z. Similarly, the term “send” includes indirect as well as direct sending. A computer X may send a message to computer Y through a network pathway including computer Z. Furthermore, the term “receive” includes receiving indirectly (e.g., through another party) as well as directly. A computer X may receive a message from computer Y through a network pathway including computer Z.

Similarly, the terms “connected to” and “coupled to” include indirect connection and indirect coupling in addition to direct connection and direct coupling. These terms include connection or coupling through a network pathway where the network pathway includes multiple elements.

To perform an action “based on” certain data or to make a decision “based on” certain data does not preclude that the action or decision may also be based on additional data as well. For example, a computer performs an action or makes a decision “based on” X, when the computer takes into account X in its action or decision, but the action or decision can also be based on Y.

In this patent, “computer program” means one or more computer programs. A person having ordinary skill in the art would recognize that single programs could be rewritten as multiple computer programs. Also, in this patent, “computer programs” should be interpreted to also include a single computer program. A person having ordinary skill in the art would recognize that multiple computer programs could be rewritten as a single computer program.

The term computer includes one or more computers. The term computer system includes one or more computer systems. The term computer server includes one or more computer servers. The term computer-readable medium includes one or more computer-readable media. The term database includes one or more databases.

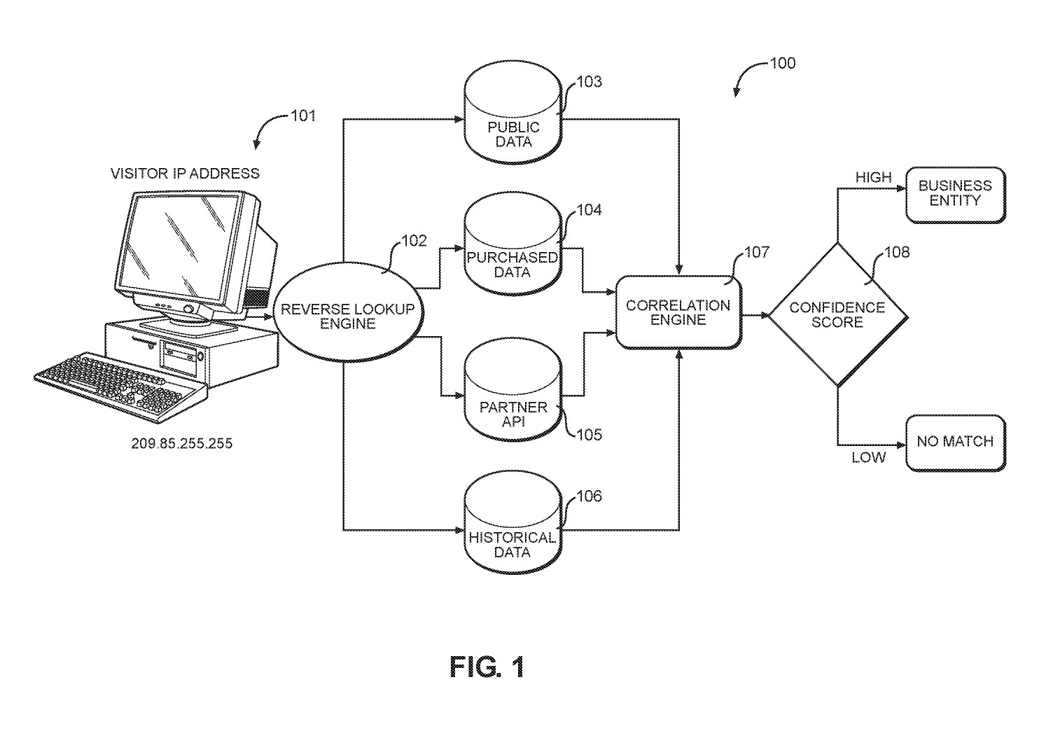

FIG. 1 illustrates an exemplary system architecture 100 that may be used in some embodiments. A visitor IP address 101 may be obtained from a user visiting website. The visitor IP address 101 may be, for example, an IPv4 or IPv6 address. Embodiments may be directed to determining the identity of a business entity that is associated with the visitor IP 101. The visitor IP address 101 may be received by and processed by the Reverse Lookup Engine 102 in various databases. The databases may include a Public Data database 103, a Purchased Data database 104, a Partner API 105, and Historical Data database 106. One way to look up information in the databases is for the Reverse Lookup Engine 102 to submit an IP address to these databases and receive entity information in response to the database lookup.

The Public Data database 103 may include public information about business entities. The Public Data in the Public Data database 103 may be collected by performing web scraping of content on the World Wide Web. The Purchased Data database 104 may include data that was purchased about business entities. The Partner API 105 may allow access to business entity information from partners through API calls. In some cases, Partner API 105 may be a service that maps IP addresses to the identity of a business entity. The Historical Data database 106 may include historical data collected from users and business entities through use of embodiments of the system. Data in the databases may include, for example, an entity information such as company name, phone number, address, industry, subindustry, region, revenue, employee count, and domain. Data in the databases may include per user information such as user name, phone number, email address, address, and so on. The information in these databases and other information may be received by and processed by the Correlation Engine 107. The Correlation Engine 107 may process the data to determine the most likely identity of an entity associated with the IP address. For example, the Correlation Engine 107 may consider information that appears in multiple sources to be more accurate. It may process this information appearing in multiple sources, or databases, and assign it a higher score. For example, if the database lookup by IP address in the Public Data database 103 and the Historical Data database 106 both indicate that the entity is “Acme Corp.” then the Correlation Engine 107 may assign a higher likelihood that the entity is in fact “Acme Corp.” Meanwhile, if information is only found in a single source, it may be processed by the Correlation Engine 107 to assign it a lower score. Moreover, when the Correlation Engine 107 determines that information from multiple sources is contradictory then it may also process the information to assign it a lower score. For example, if the sources, or databases, disagree on the entity identity, then the entity identity may be given a lower score by the Correlation Engine 107. If an IP address has been used by multiple users with different entity information, then this information may be logged over multiple events and the Correlation Engine 107 may assign a lower confidence value.

The Correlation Engine 107 produces a confidence score 108 on its results. If the information is given a high confidence score, then the Correlation Engine 107 returns the information and the high confidence score. If the information is given a low confidence score, then the Correlation Engine 107 may return no match and an indication of the low confidence.

In one embodiment, the Reverse Lookup Engine 102 may perform a geolocation on the IP address 102 to determine a geographic region of the user. The Correlation Engine 107 may use the geographic region information to restrict the group of entities it will return to those that have a location or physical address within the geographic region. The Correlation Engine 107 may use this process as an initial filter to limit the set of potential business entities before performing additional processing to entities of highest likelihood.

In one embodiment, the Reverse Lookup Engine 102 may look up historical information about prior web form submissions made from the IP address 101 and provide that information to the Correlation Engine 107. The Correlation Engine 107 may determine potential entities associated with the IP address by finding and evaluating entries that were submitted in Company Name or Email Address fields of web forms. Entity information may be determined from an Email Address field by looking at the domain name, and associating the domain name to an entity. The Correlation Engine 107 may determine how many past web form submissions from the particular IP address are recorded in the Historical Data database 106 for an entity, namely the web form submission included the entity name in the company name field or the domain name of the user's email address was associated with the entity. When it determines that a large number of web form submissions from an IP address are for an entity, it may assign a higher probability that it is the correct entity identity. However, if few web form submission from an IP address are for an entity, or web form submission from the IP address identify several different possible entities, then the Correlation Engine 107 may assign a lower probability that the entity identity is correct.

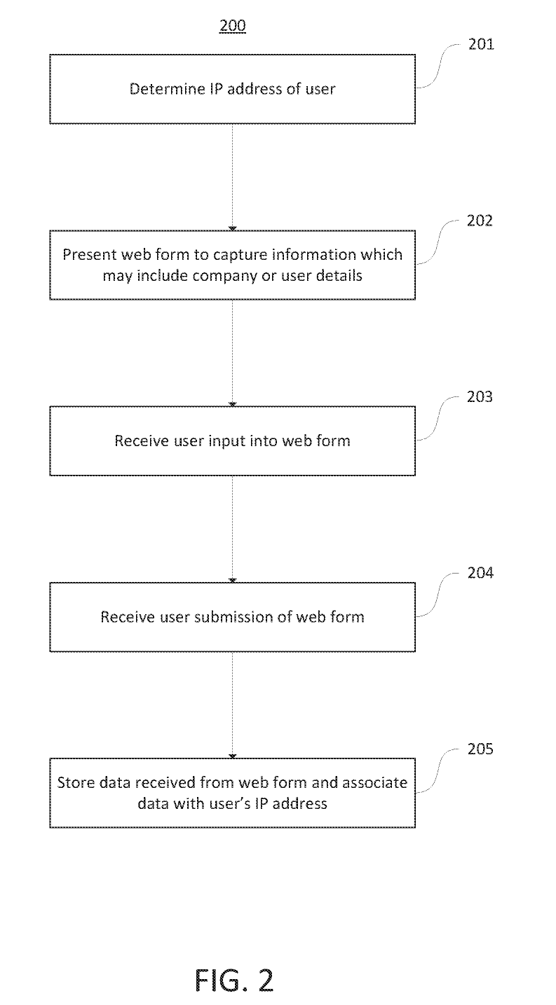

FIG. 2 illustrates an exemplary method 200 for storing information submitted in a web form associated with an IP address that may be used in one embodiment of the invention. In step 201, an IP address of the user is determined. The IP address of the user may be determined for example from the HTTP request. In step 202, a web form on a website is presented to the user. The web form may include one or more fields. The fields may include company information such as company name, phone number, address, industry, subindustry, region, revenue, employee count, and domain. The fields may include user information such as user name, phone number, email address, address, and so on. The fields may be text fields and in some cases may allow the upload of files. The web form may be a Hypertext Markup Language (HTML) form or other form such as a Flash form or Silverlight form. In step 203, input may be received from the user in one or more fields of the web form. In step 204, a request to submit the form may be received from the user. In step 205, in response to submission of the form, an API call may be made causing data from one or more fields of the web form to be stored in a database and associated in the database with the IP address of the user. The API call may be, for example, a Javascript function call to a server-side function. In one possible implementation, a Javascript function reads data from one or more fields of the web form and also reads the visitor IP address and transmits this data to a server. The server may perform a server-side callback function to store the data from the one or more fields of the web form and the IP address. It may store the data and the IP address in a database connected to the server.

In some embodiments, a MySQL database may be used. A MySQL database may include one or more tables. The tables may include one or more columns corresponding to fields of information. Data collected from one or more fields of a web form may be associated with an IP address of a user by storing the data in a row of a MySQL table, or by storing the data in rows of different tables where the rows share a same index on at least one column. Data from web fields may be stored to be associated with an IP address of a user in many other ways as well.

The database in which the information from the one or more web fields and the IP address of the user may be stored may be the Historical Data database 106 shown in FIG. 1. The Historical Data database 106 may store historical information about user visits and usage of websites.

The Historical Data database 106 may include information stored each time the user completes a web form. This may be useful to increase the confidence that the data is correct. For example, even if an association between an IP address and certain information is already stored, the information may be stored again in a new entry so that the Correlation Engine 107 may determine that the same information was entered multiple times and therefore is more likely to be correct. Alternatively, rather than storing information multiple times, the system may store one or more counters that may be incremented each time the same data or associations are seen. For example, each time an association between certain information, such as entity identity, and an IP address is determined, a counter corresponding to that association of information may be incremented.

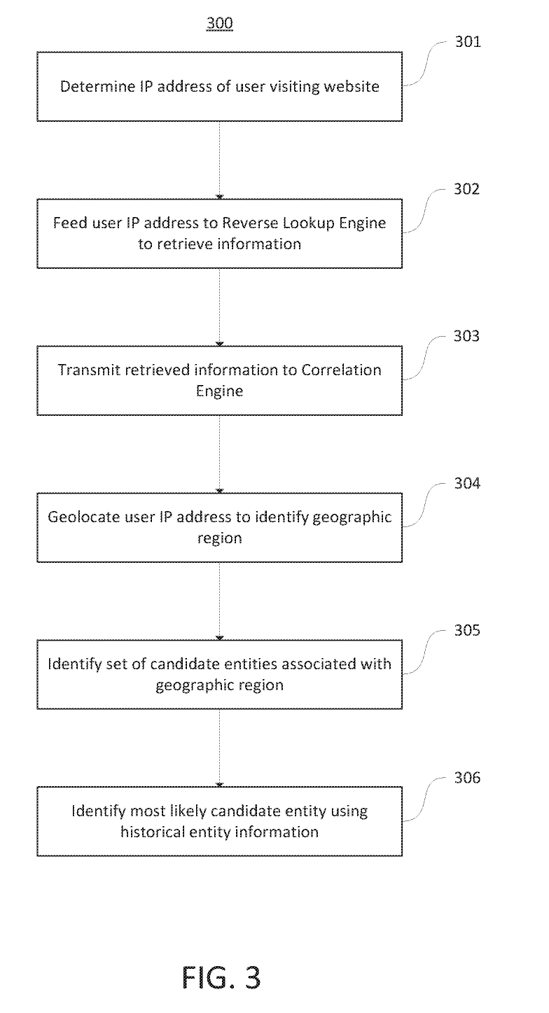

FIG. 3 illustrates an exemplary method 300 for associating an entity identity to an IP address that may be used in one embodiment of the invention. In step 301, a visitor visits a website and an IP address 101 of the user is determined. In step 302, the IP address 101 is fed into Reverse Lookup Engine 102, which looks up information in one or more databases including the Historical Data database 106. The Reverse Lookup Engine 102 may be activated by an API call such as a Javascript function call that transmits the IP address of the user to a server. The server may process the IP address with a server-side function callback. The Reverse Lookup Engine 102 may be performed as a server-side function. In step 303, the Reverse Lookup Engine 102 transmits the looked up information to the Correlation Engine 107. In step 304, the Correlation Engine 107 geolocates the IP address of the user to identify a geographic region. In step 305, the Correlation Engine 107 identifies a candidate set of entities that have locations in, or are associated with, the geographic region. In step 306, the Correlation Engine 107 uses historical entity information entered in web forms to identify the most likely entity in the candidate set of entities, where the historical entity information includes information entered into a company name field or email address field of a web form.

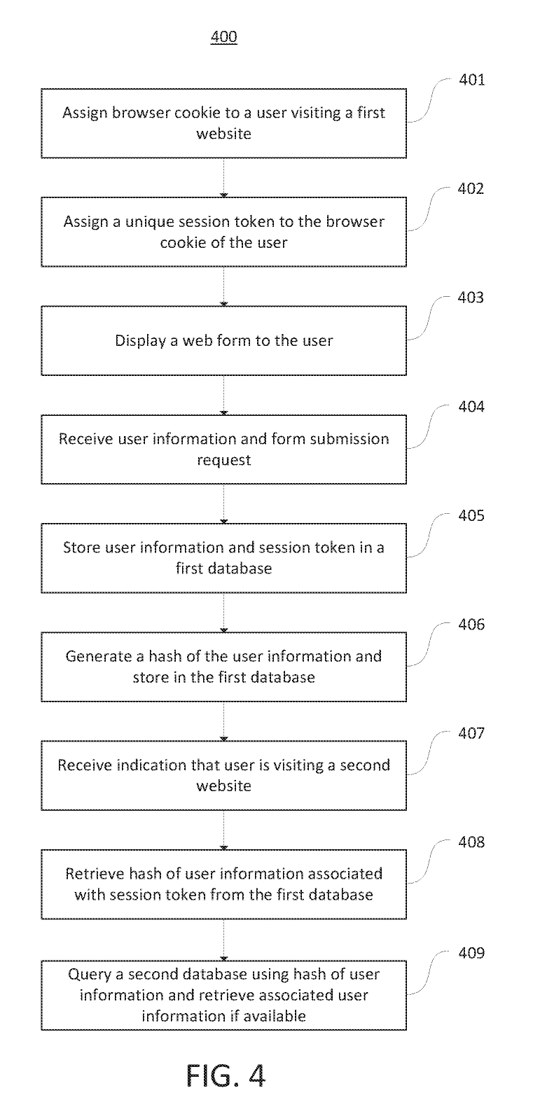

FIG. 4 illustrates an exemplary method 400 for retrieving user information from a different location or database that may be used in one embodiment of the invention. In step 401, a browser cookie is assigned to a user of a first website. In step 402, a unique session token is assigned to the browser cookie of the user. The session token may track the activity of the user across websites. In step 403, a web form is displayed to the user on the first website. The web form may include one or more fields. The fields may include user information such as name, phone number, email address, address, and so on. In step 404, text input is received from the user in the web form of the first website, where text input may include one or more fields of user information. A submit form request is received from the user and the form data is received. For example, a user's email address may be received. In step 405, the unique session token and user information, such as email address, are stored on a server. In some embodiments, additional information identifying the user session may also be stored, such as IP address. Storage of the information may be made in a first database. In step 406, the server may generate a hash of user information, such as computing a hash of the user email address submitted through the web form. The hash may be generated using MD5, SHA1, or another deterministic hashing algorithm. For example, an MD5 hash of the user email may be generated. The hash of user information may be stored with the session token and other user information on the server, such as in the first database. In step 407, an indication is received at a second website that the user is visiting the second website, where the user's session token has been maintained in a browser cookie. In step 408, in response to a script encoded on the second website, the user's browser transmits a request to the server based on the user's session token in order to receive the hash of user information from the server. The server transmits the hash of user information, which is then received by the web browser and stored in a window variable of the browser. This process may be implemented as an API call to the server. For example, the second website may retrieve the MD5 hash of the user email using an API call. In step 409, the second website may read the hash from the window variable and use it as a key to look up information in a different database, such as a database maintained by the owner of the website, which stores hashes as keys associated with user information as values. The database lookup on the hash may return the user information. For example, the second website may look up the MD5 hash in a user records database and identify corresponding information of the user. As a result, the method 400 may allow the second website to associate history of a user as tracked by the session token, central information stored from a first database, and local information from a second database.

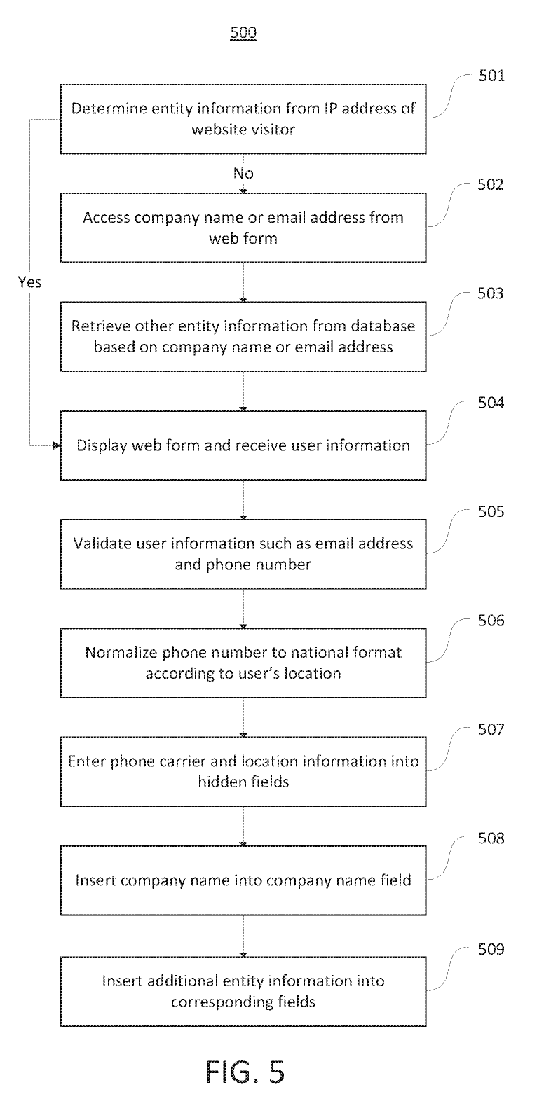

FIG. 5 illustrates an exemplary method 500 for validating or inserting information into a web form that may be used in one embodiment of the invention. Method 500 may include in some embodiments hidden form fields. Hidden form fields are fields that contain information but are not displayed to the user. For example, HTML hidden fields are hidden form fields. Hidden form fields may be submitted when a form is submitted. In step 501, entity information may be determined from an IP address of the website user. In one embodiment, entity information may be determined by feeding the user's IP address to the Reverse Lookup Engine 102, and entity information would be returned by the Correlation Engine 107 such as via method 300. In step 502, if entity information cannot be determined from the IP address of the website user, identifying fields in a web form are accessed. Identifying fields may be used to uniquely identify a company and may include company name, email address, phone number or other fields. For example, in some instances company name, email address domain, or phone number may be uniquely associated with a company. In other instances, email address or phone number may be associated with a user who is then associated with a company. In step 503, entity information may be determined by retrieving information from a database which is associated with the identifying fields in the web form. In step 504, a web form is displayed to the user. The web form may include one or more fields, which may include user information, company information, or a combination thereof. Input is received from the user in the web form. A submit form request is received from the user and the form data is received. In step 505, information such as email address and phone number entered by the user in the web form may be validated. Information may be validated based on known formats or values. For example, a phone number may be checked for inclusion of country code, area code, or a correct number of digits. A country code or area code may be checked against known values for a given user or company location. The validation may be activated by an API call to a server. A valid or invalid response may be returned by the server. In the case of an invalid response, the user may be asked to correct fields which were considered invalid. In step 506, a phone number may be normalized into a national format according to the geographic location of the entity that the user is a member of. For example, a country code may be prepended to the phone number. In step 507, phone carrier and location information may be entered into separate hidden form fields. In step 508, company name may be automatically entered into a company name field of the form if it is available based on the retrieved entity information. Company name field may be a hidden form field. In step 509, additional entity information may be entered into corresponding fields of the form if available in the retrieved entity information. These fields may be hidden form fields. Additional entity information may include phone number, address, industry, subindustry, region, revenue, employee count, domain and other information.

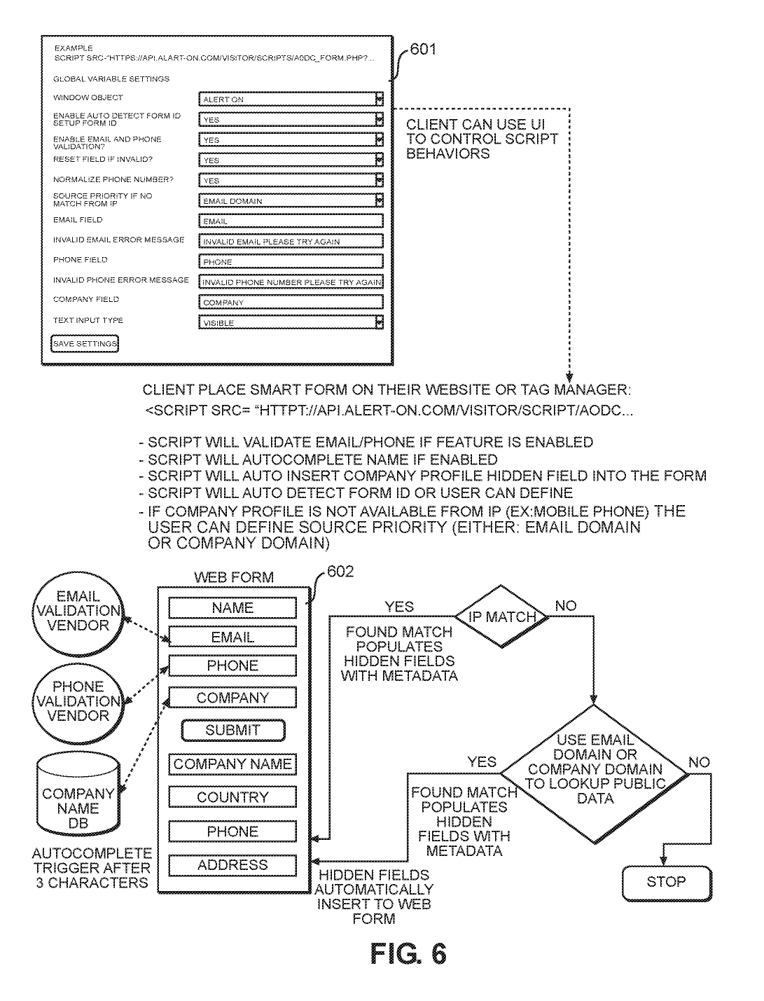

FIG. 6 illustrates an exemplary web form 602 which may be used in one embodiment to perform method 500. A web form 602 may be generated through a smart form script. The smart form script may be configurable to adjust the behavior of the web form 602. In some embodiments, the configuration may happen through a graphical user interface 601. Examples of behaviors which may be configured include validation of email address or phone number, automatic insertion of information into hidden fields, and automatic completion of fields such as company name. In another example, behavior may be configured to prioritize certain data sources when performing automatic insertion or automatic completion of fields with more than one possible data source.

The web form 602 may be configured to interact with services such as external vendors or databases. In some embodiments, a vendor service may be used for validation of email address or phone number. In some embodiments, a database may be used to suggest candidates for automatic completion of fields.

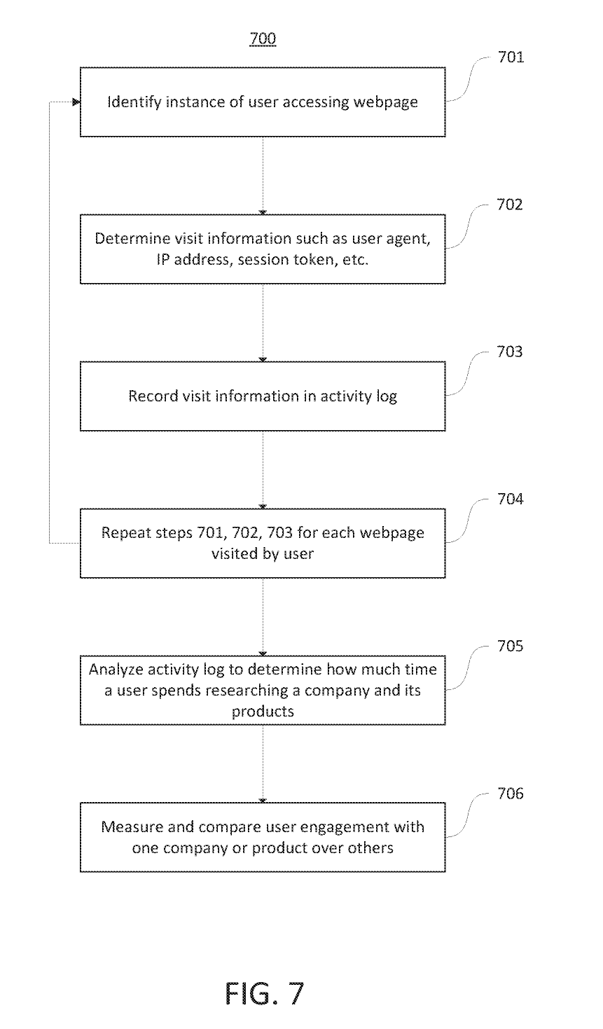

FIG. 7 illustrates an exemplary method 700 for tracking a user journey and inferring user interest that may be used in some embodiments of the invention. In step 701, a user visits a website, and the access is identified by the system. The access may be identified by tracking http requests. In step 702, the user's visit information is determined. Visit information may include user agent, IP address, session token, referring website, current website, time spent on website, and other information. In step 703, the user's visit information is stored in an activity log and associated with the user. The activity log may be implemented as a database. In step 704, steps 701-703 are repeated for each website that the user visits. The logging process may be repeated for website visits in single web session, across multiple sessions, or across multiple days. In step 705, machine learning is used to analyze an activity log of the user's website visits and to determine how much time a user spends researching a company and its products. Machine learning may infer time spent on research from website access patterns or attribute time spent on certain websites to research of certain products or companies. In step 706, user engagement with certain products or companies can be measured and compared based on user activity such as time spent on websites, download of materials, attendance of online or offline events, and communication through email or social media.

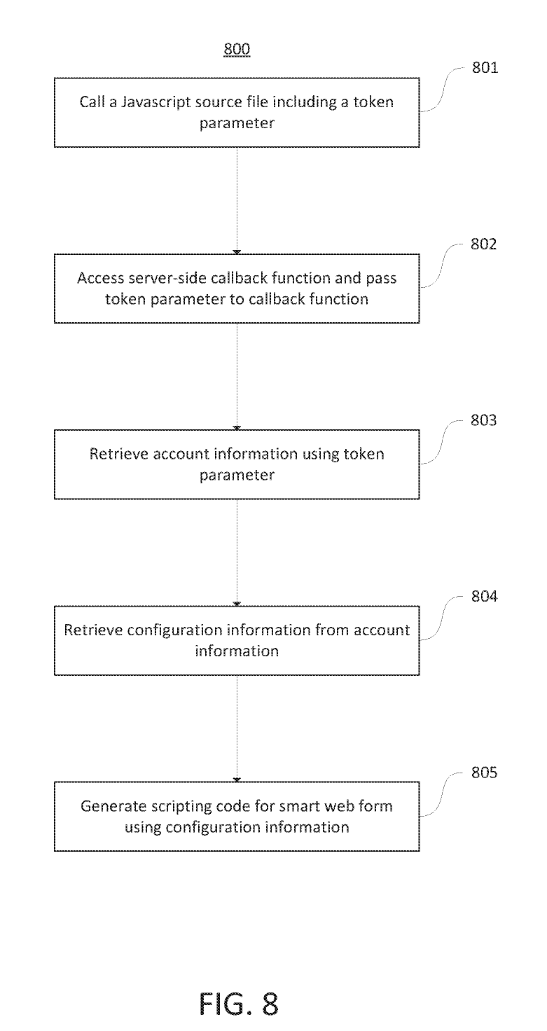

FIG. 8 illustrates an exemplary method 800 for implementing methods herein with a single HTML tag to include Javascript code that may be used in some embodiments of the invention. In some embodiments, the functionality described herein, such as but not limited to methods 200, 300, 400, 500, and 700, is implemented by including a single Javascript source code file on a webpage. This is different from other competing technologies that require multiple source files or complex configuration. The single Javascript source code file provides the functionality of the methods by transmitting and receiving requests from a backend server. In some embodiments, the single Javascript source code file can be configured from a user interface to allow different behavior on the website.

After the Javascript source code is included, in step 801, a Javascript source file is called, which includes a token parameter that uniquely identifies a user account. In step 802, a server-side callback function is accessed by the Javascript code. The token is passed as a parameter to the server-side callback function. In step 803, the token parameter is used to retrieve account information. In step 804, configuration information is retrieved from the account information. Configuration of the account may be performed from a user interface, such as a visual web interface. In step 805, scripting code for a smart web form is automatically generated using the configuration information. The scripting code may perform method 500. The scripting code may also perform methods, 200, 300, 400, and 700.

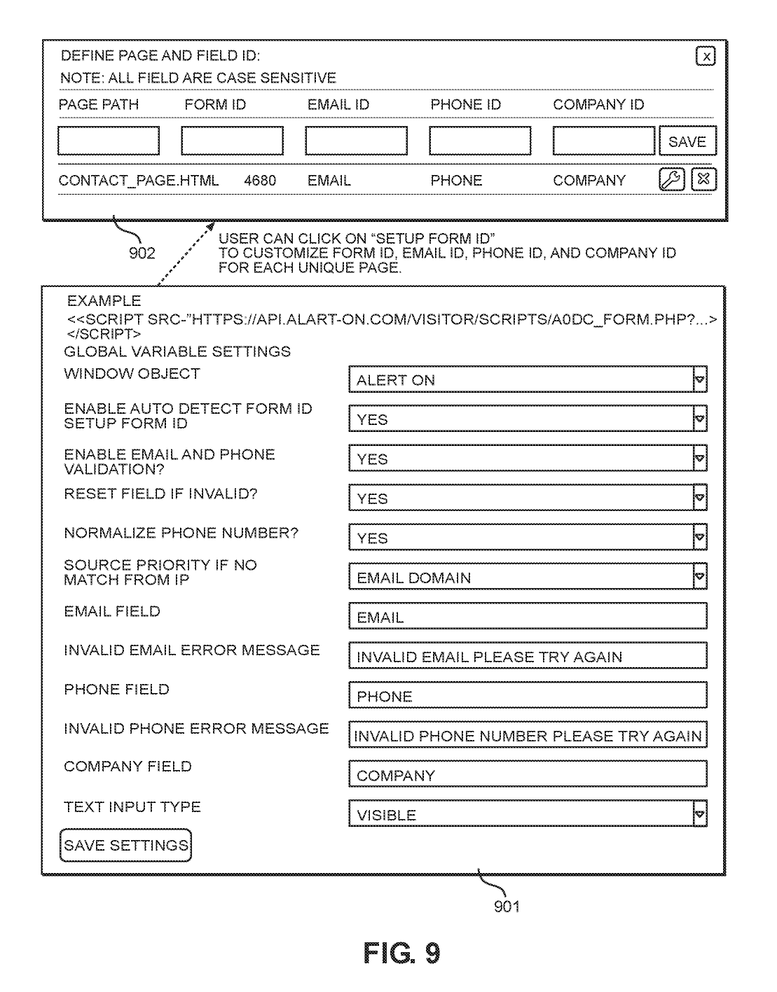

FIG. 9 illustrates an exemplary user interface 901 which may be used to generate and control the behaviors of web form 902 in some embodiments. After the Javascript source code file is included on a website as described above, the user interface may be used to configure web form behaviors without requiring changes to the code of the web form or code of the smart form script that generates the web form. One or more settings may be included which configure different aspects of web form behavior. Settings may be input through multiple choice options or text entry. Settings may include Window Object, Form ID, Autodetection of Form ID, Field Validation, Invalid Field Action, Field Normalization, Source Priority, Field ID, Invalid Field Message, Company Field ID, and Text Input Type. A link may be displayed which generates an example web form using the configuration settings specified in the user interface.

Window Object may specify which web page or frame the web form should appear on. Form ID may identify the HTML form ID of a form. Form ID may also be auto-detected based on web page context or specified by the user. A setup link may be included for the user to specify form ID or other information. The setup link may be used to save varying configurations for different webpages. Field Validation may enable or disable validation for certain fields. Invalid Field Action may specify the action to take if given an invalid field. For example, an action may be to clear the field, leave the field as-is, or mark the field in a certain way. Field Normalization may specify fields such as phone number to be normalized to a standard format. Source Priority may specify which data field to be given priority in determining entity identity if entity identity may be inferred from multiple fields. For example, two options for source priority are company name field or email domain because entity identity can be inferred from each. Field ID may specify which form field corresponds to a database item or which database item corresponds to a form field. Invalid Field Message may specify a message to display if given an invalid field. Company Field ID may identify the HTML web form ID of the field containing the company name. Text Input Type may specify how input text is displayed for text input fields. For example, text input may be displayed normally, obscured for sensitive fields, or not displayed at all.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects. Rather, the scope of the invention should be determined with reference to patent claims.

1. A system for determining information about a user of a website comprising:
a historical data database storing data about past web form entries associated with a plurality of IP addresses;
a reverse lookup engine configured to retrieve the past web form entries from the historical data database based on a visitor IP address;
a correlation engine configured to determine entity information of a current user at the visitor IP address based on the retrieved past web form entries, the correlation engine configured to output the entity information.

2. The system of claim 1, further comprising a public data database configured to store public information about a plurality of entities and wherein the reverse lookup engine is further configured to retrieve information from the public data database and the correlation engine is further configured to determine the entity information of the current user at the visitor IP address based on the retrieved information.

3. The system of claim 1, further comprising a partner API configured to allow access to entity information stored by one or more partners and wherein the reverse lookup engine is further configured to retrieve information from the partner API and the correlation engine is further configured to determine the entity information of the current user at the visitor IP address based on the retrieved information.

4. The system of claim 1, further comprising a geolocator for geolocating the current user based on the visitor IP address to generated a predicted location, wherein the correlation engine uses the predicted location to generate a set of candidate entities for using to determine the entity information of the current user at the visitor IP address.

5. The system of claim 1, wherein the correlation engine generates a confidence score corresponding to the entity information.

6. The system of claim 1, further comprising a web form for collecting user information, the web form for storing web form entries associated with a submission IP address in the historical data database when the web form is submitted.

7. The system of claim 6, wherein the web form includes embedded scripting code.

8. The system of claim 7, wherein the embedded scripting code controls one or more behaviors of the web form based on configuration entries of a second web form.

9. The system of claim 1, further comprising a web form of a website, the web form including a hidden field, wherein the correlation engine is configured to populate the hidden field with the entity information.

10. The system of claim 1, wherein the retrieved past web form entries include a domain name.

11. A method for determining information about a user of a website comprising:
storing, by a historical data database, data about past web form entries associated with a plurality of IP addresses;
retrieving, by a reverse lookup engine, the past web form entries from the historical data database based on a visitor IP address;
determining, by a correlation engine, entity information of a current user at the visitor IP address based on the retrieved past web form entries;
outputting the entity information.

12. The method of claim 11, further comprising:
storing, by a public data database, public information about a plurality of entities;
retrieving, by the reverse lookup engine, information from the public data database;
determining, by the correlation engine, the entity information of the current user at the visitor IP address based on the retrieved information.

13. The method of claim 11, further comprising:
allowing access, by a partner API, to entity information stored by one or more partners;
retrieving information, by the reverse lookup engine, from the partner API;
determining, by the correlation engine, the entity information of the current user at the visitor IP address based on the retrieved information.

14. The method of claim 11, further comprising:
geolocating the current user based on the visitor IP address to generate a predicted location;
using, by the correlation engine, the predicted location to generate a set of candidate entities;
using the set of candidate entities to determine the entity information of the current user at the visitor IP address.

15. The method of claim 11, further comprising generating, by the correlation engine, a confidence score corresponding to the entity information.

16. The method of claim 11, further comprising:
displaying a web form for collecting user information;
storing web form entries associated with a submission IP address in the historical data database when the web form is submitted.

17. The method of claim 16, wherein the web form includes embedded scripting code.

18. The method of claim 17, further comprising controlling, by the embedded scripting code, one or more behaviors of the web form based on configuration entries of a second web form.

19. The method of claim 11, further comprising:
displaying a web form of a website, the web form including a hidden field;
populating, by the correlation engine, the hidden field with the entity information.

20. The method of claim 11, wherein the retrieved past web form entries include a domain name.
